(19) United States
(12) Patent Application Publication
(10) Pub. No.: US 2010/0294660 A1
(43) Pub. Date: Nov. 25, 2010

(54) Glucose Testing Device And Strips For Same

(75) Inventors: Shiow-Chen Wang, Taipei (TW); Wen Hai Tsai, Taipei (TW); Jih-Hsin Yeh, Taipei (TW); Chia Jung Chen, Changhua (TW); Hung Chih Lin, Taipei (TW); Keng Hao Chang, Taichung (TW); Yi-Chi Yang, Taichung (TW)

Correspondence Address: Jenny Chen;Eastwind Consultants Company Limited, 7F, No. 1, Alley 30, Lane 358,, Rueiguang Road, Neihu District, Taipei, 114, TW

(73) Assignee: Tyson Bioresearch, Inc.

(21) Appl. No.: 12/722,567

(22) Filed: Mar. 12, 2010

Related U.S. Application Data
(60) Provisional application No. 61/160,286, filed on Mar. 13, 2009.
(60) Provisional application No. 61/181,298, filed on May 27, 2009.

(51) Int. Cl. G01N 27/327; G01N 27/26

(52) U.S. Cl. 204/403.14

(57) ABSTRACT

The present invention provides an electrochemical biosensor. The biosensor includes a substrate; a metal layer disposed on the substrate, wherein a first end of the metal layer is formed with a reaction region by a working electrode and a reference electrode provided on the metal layer, the reaction region is applied with an enzyme so that an electrical response is generated when the enzyme and a test sample form a chemical reaction, and a second end of the metal layer is provided with an integrated information unit to provide both test sample information and coding information.

This application is related to and claims priority to U.S. provisional patent applications, U.S. provisional application No. 61/160,286, filed on Mar. 13, 2009, by the applicants Shiow-Chen Wang, Wen Hai Tsai, Jih-Hsin Yeh, Chia Jung Chen, Hung Chih Lin, and Keng Hao Chang, entitled “Glucose meters and strips for same,” and U.S. provisional application No. 61/181,298, filed on May 27, 2009, by the applicants Shiow-Chen Wang, Wen-Hai Tsai, Keng-Hao Chang, and Yi-Chi Yang, entitled “Glucose testing device.”

### FIELD OF THE INVENTION

The present invention relates to glucose testing device and strips for same; more particularly, the present invention relates to glucose testing strips with integrated information provided thereon to provide both test sample information and coding information.

### BACKGROUND OF THE INVENTION

Electrochemical biosensors have been commonly used in connection with electrochemical biosensor testing devices to determine the concentration of various analytes from test samples. For example, in blood glucose testing, a blood sample may be dropped on a test strip applied with an enzyme, and then the test strip is inserted into a glucose meter to determine the concentration of glucose in the blood sample.

In the conventional art, the test strip is provided with a working electrode and a reference electrode to form a reaction region. The reaction region is applied with an enzyme so that when a test sample reacts with the enzyme, a chemical response is generated. When in use, the test strip is inserted in the glucose meter so that the glucose meter can read the chemical response in order to calculate the concentration of glucose.

However, as a result of variances in the manufacturing of the test strips, a code card needs to be provided before using a particular batch of the test strips, so that a calibration code corresponding to the particular batch of the test strips may be stored in the glucose meter to accurately calculate the test result. Manufacturing the code card would increase manufacturing cost. Additionally, with the additional step of inserting the code card into the glucose meter before use, the chance of human error also increases.

Therefore, what is needed is a test strip capable of containing both test sample information and coding information so that a glucose meter can accurately calculate a test result based on the information contained on the test strip with minimal user intervention.

### SUMMARY OF THE INVENTION

In light of the drawbacks of the above prior art, the present invention provides an electrochemical biosensor with an integrated information unit to provide both test sample information and coding information.

One object of the present invention is to provide an electrochemical biosensor. The biosensor includes a substrate; a metal layer disposed on the substrate, wherein the first end of the metal layer is formed with a reaction region by a working electrode and a reference electrode provided on the metal layer, the reaction region is applied with an enzyme so that an electrical response is generated when the enzyme and a test sample form a chemical reaction, and the second end of the metal layer is provided with an integrated information unit to provide both coding information about the biosensor and the electrical response, wherein the integrated information unit is provided with a plurality of digital on and off points capable of generating signals corresponding to the coding information and the electrical response.

Another object of the present invention is to provide an electrochemical biosensor. The biosensor includes a substrate; a non-metal layer disposed on the substrate, wherein the first end of the non-metal layer is formed with a reaction region by a working electrode and a reference electrode provided on the non-metal layer, the reaction region is applied with an enzyme so that an electrical response is generated when the enzyme and a test sample form a chemical reaction; a conductive film layer having an integrated information unit provided thereon so as to provide both coding information about the biosensor and the electrical response, wherein the integrated information unit is provided with a plurality of digital on and off points capable of generating signals corresponding to the coding information and the electrical response.

Yet another object of the present invention is to provide an electrochemical biosensor testing device for use with a biosensor provided with an integrated information unit containing both coding information about the biosensor, and an electrical response generated when an enzyme applied on a reaction region formed by a working electrode and a reference electrode provided on the biosensor forms a chemical reaction with a test sample. The testing device includes a housing defining an slot for receiving the biosensor; a single connector having a plurality of terminals for electrically coupling to the biosensor; and a microcontroller electrically coupled to the single connector so as to calculate a test result, wherein the single connector is capable of transmitting both the coding information and the electrical response to the microcontroller.

Yet another object of the present invention is to provide an electrochemical biosensor testing device for use with a biosensor provided with an integrated information unit containing both coding information about the biosensor, and an electrical response generated when an enzyme applied on a reaction region formed by a working electrode and a reference electrode provided on the biosensor forms a chemical reaction with a test sample. The testing device includes a housing defining an slot for receiving the biosensor; the first connector and the second connector, each having a plurality of terminals for electrically coupling to the biosensor; and a microcontroller electrically coupled to the first and the second connectors so as to calculate a test result, wherein the first connector is capable of transmitting the coding information to the microcontroller, whereas the second connector is capable of transmitting the electrical response to the microcontroller.

Yet another object of the present invention is to provide an electrochemical biosensor testing system. The system includes a biosensor provided with an integrated information unit containing both coding information about the biosensor, and an electrical response generated when an enzyme applied on a reaction region formed by a working electrode and a reference electrode provided on the biosensor forms a chemical reaction with a test sample; and a biosensor testing device with a housing defining an slot for receiving the biosensor, the testing device having a single connector with a plurality of terminals for electrically coupling to the biosensor, and a microcontroller electrically coupled to the single connector so as to calculate a test result based on the coding information and the electrical response, wherein the integrated information unit is provided with a plurality of digital on and off points to generate signals corresponding to the electrical response and the coding information.

### BRIEF DESCRIPTION OF DRAWING

FIGS. 1a and 1b are schematic diagrams of an exemplary biosensor in accordance with one embodiment of the present invention;

FIGS. 2a and 2b are schematic diagrams of another exemplary biosensor in accordance with one embodiment of the present invention;

FIG. 3a is a block diagram of an exemplary biosensor testing system in accordance with one embodiment of the present invention;

FIG. 3b is a schematic diagram of an implementation of a general purpose input/output in connection with an microcontroller in accordance with one embodiment of the present invention; and

FIG. 4 is a schematic view of an internal structure of a biosensor testing device in accordance with one embodiment of the present invention.

### DETAILED DESCRIPTION OF THE INVENTION

The present invention will now be described through the following embodiments. However, it is understood by those skilled in the art that the embodiments described below are for illustration purpose only and are not intended to limit the scope of the present invention. Similar reference numbers refer to similar components in the accompanying drawings throughout the specification.

The present invention discloses a biosensor, a biosensor testing device and a biosensor testing system. The biosensor in accordance with the present invention is equipped with an integrated information unit to provide both test sample information and coding information specific to the biosensor so that a test result can be more accurately calculated by the biosensor testing device.

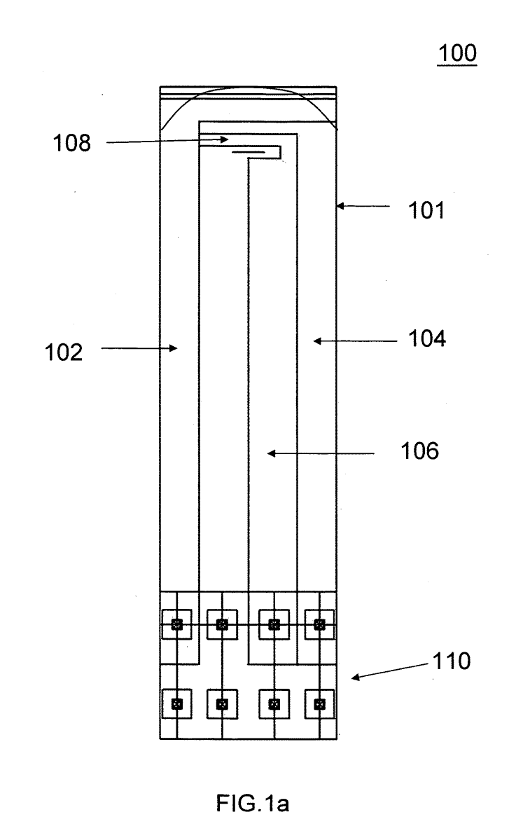

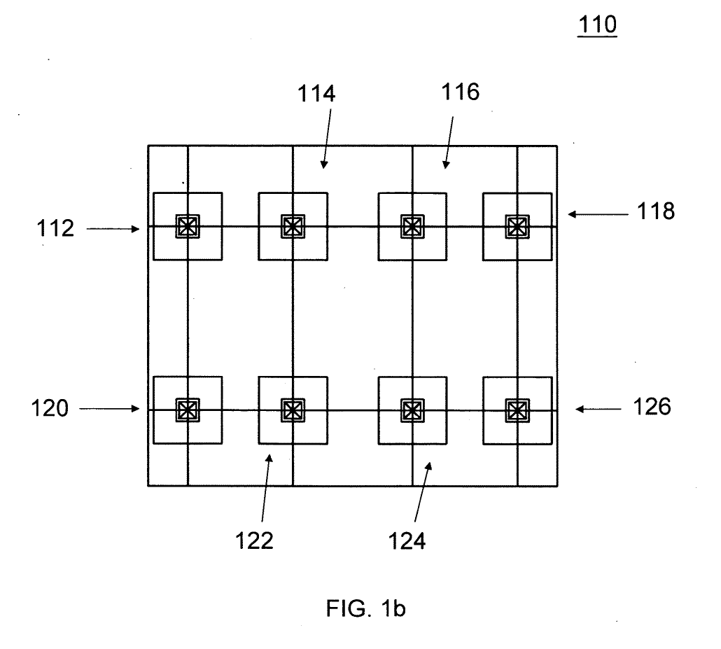

Refer now to FIGS. 1a and 1b, which are schematic diagrams of an exemplary biosensor in accordance with one embodiment of the present invention. In one embodiment of the present invention, the biosensor 100 may include a substrate (not shown) and a metal layer 101. The substrate (not shown) may be made of an insulating material, such as polyethylene terephthalate (PET) or the like. In accordance with the present invention, the metal layer 101 may be pasted on the substrate (not shown). FIG. 1a shows the metal layer 101 covering the entire substrate (not shown); however, in another embodiment of the present invention, the metal layer 101 may be partially covering the substrate (not shown) so that a portion of the substrate (not shown) may be exposed.

The metal layer 101 of the present invention may be provided with a plurality of electrodes. As shown in FIG. 1a, in one embodiment, the metal layer 101 may be provided with a working electrode 102 and a reference electrode 104. The working electrode 102 and the reference electrode 104 may be made of the first metal material, such as silver, to form a reaction region 108 at one end of the metal layer 101, such as the first end of the metal layer 101. In accordance with the present invention, the reaction region 108 may be applied with an enzyme so that when a test sample performs a chemical reaction with the enzyme at the reaction region 108, an electrical response may be generated.

In another embodiment, in addition to the working electrode 102 and the reference electrode 104, the metal layer 101 may be provided with a counter electrode 106, also called an auxiliary electrode. The counter electrode 106 may be used to make a connection to the electrolyte so that a current can be applied to the working electrode 102. In one embodiment of the present invention, the counter electrode 106 may be made of an inert material, such as a noble metal, to keep it from dissolving.

In one embodiment of the present invention, an integrated information unit 110 may be provided at another end of the metal layer 101, such as the second end of the metal layer 101. In the embodiment where the integrated information unit 110 is provided on the metal layer 101, the integrated information unit 110 may be formed by cutting on the second end of the metal layer 101 so as to create different resistances on the metal layer 101. In one example, the cutting process may be a laser cutting process. In another embodiment of the present invention, the integrated information unit 110 may be formed by a thermal, IR, or UV curing process.

In the example of laser cutting process mentioned above, the integrated information unit 110 may be formed by laser cutting a number of strips in different lengths or widths at the second end of the metal layer 101. The different lengths or widths of strips would result in different resistances on the metal layer 101, thereby creating different electrical signals to correspond to test sample information or coding information on the biosensor 100.

In one embodiment of the present invention, the integrated information unit 110 may be provided on the same side of the metal layer 101 as the working electrode 102 and the reference electrode 104. In other words, with respect to the metal layer 101, the information unit 110 and the working electrode 102 as well as the reference electrode 104 may be facing up. In another embodiment of the present invention, the integrated information unit 110 may be provided on the side of the metal layer 101 opposite to the side where the working electrode 102 and the reference electrode 104 are provided. In other words, with respect to the metal layer 101, the working electrode 102 and the reference electrode 104 may be facing up, while the information unit 110 may be facing down.

In another embodiment of the present invention, the integrated information unit 110 may be provided on a conductive film (not shown). The conductive film (not shown) may be disposed on the metal layer 101. The conductive film 203 may be made of Indium Tin Oxide (ITO), Indium Zinc Oxide (IZO) or the like. In the embodiment where the integrated information unit 110 is provided on the conductive film (not shown), the integrated information unit 110 may be formed by cutting on the conductive film (not shown) so as to create different resistances on the conductive film (not shown). In one example, the cutting process may be a laser cutting process. In another embodiment of the present invention, the integrated information unit 110 may be formed by a thermal, IR, or UV curing process.

In one embodiment of the present invention, the integrated information unit 110 may be made of the same material as that of the working electrode 102 and the reference electrode 104. In another embodiment of the present invention, the integrated information unit 110 may be made of a different material.

In one embodiment of the present invention, the integrated information unit 110 may be provided on the same side of the metal layer 101 as the working electrode 102 and the reference electrode 104. In other words, with respect to the metal layer 101, the information unit 110 and the working electrode 102 as well as the reference electrode 104 may be facing up. In another embodiment of the present invention, the integrated information unit 110 may be provided on the side of the metal layer 101 opposite to the side where the working electrode 102 and the reference electrode 104 are provided. In other words, with respect to the metal layer 101, the working electrode 102 and the reference electrode 104 may be facing up, while the information unit 110 disposed on the conductive film (not shown) may be facing down. In one embodiment of the present invention, the conductive film (not shown) may cover at least the second end of the metal layer 101 while exposing the reaction region 108 at the other end of the metal layer 101.

The integrated information unit 110 of the present invention may contain both test sample information and coding information. In one embodiment, the test sample information may include the electrical response generated when a test sample, such as blood, performs a chemical reaction with the enzyme at the reaction region 108, whereas the coding information may include code patterns, which uniquely identify a particular biosensor, calibration information, or other safety information to prevent any improper operation.

As shown in FIG lb, the integrated information unit 110 of the present invention may include a plurality of digital on and off points, such as points 112, 114, 116, 118, 120, 122, 124 and 126. Although FIG. 1b shows 8 digital on and off points, those skilled in the art should know that the integrated information unit 110 may include more or less than 8 digital on and off points to generate signals corresponding to the test sample information and the coding information.

In one embodiment of the present invention, the plurality of digital on and off points 112, 114, 116, 118, 120, 122, 124 and 126 may be divided into the first group and the second group. For example, the digital on and off points 112, 116 and 118 may belong to the first group while the digital on and off points 114, 120, 122, 124 and 126 may belong to the second group. In another example, the digital on and off points 112, 114, 116 and 118 may belong to the first group while the digital on and off points 120, 122, 124 and 126 may belong to the second group. However, those skilled in the art should know that the present invention is not limited to these arrangements. Any other ways of grouping the plurality of digital on and off points 112, 114, 116, 118, 120, 122, 124 and 126 are included in the present invention.

In one embodiment of the present invention, the first group of the plurality of digital on and off points, for example, digital on and off points 112, and 118 may be electrically coupled to the working electrode 102 and the reference electrode 104, respectively, so as to generate signals corresponding to the test sample information. Optionally, the digital on and off points 116 may be electrically coupled to the counter electrode so as to generate signals corresponding to the test sample information. As discussed above, the test sample information may include the electrical response generated when a test sample performs a chemical reaction with the enzyme at the reaction region 108. On the other hand, the second group of the plurality of digital on and off points, for example, digital on and off points 114, 120, 122, 124 and 126 may be capable of generating signals corresponding to the coding information. As discussed above, the coding information may include code patterns, which uniquely identify a particular biosensor, calibration information, or any other safety information to prevent any improper operation.

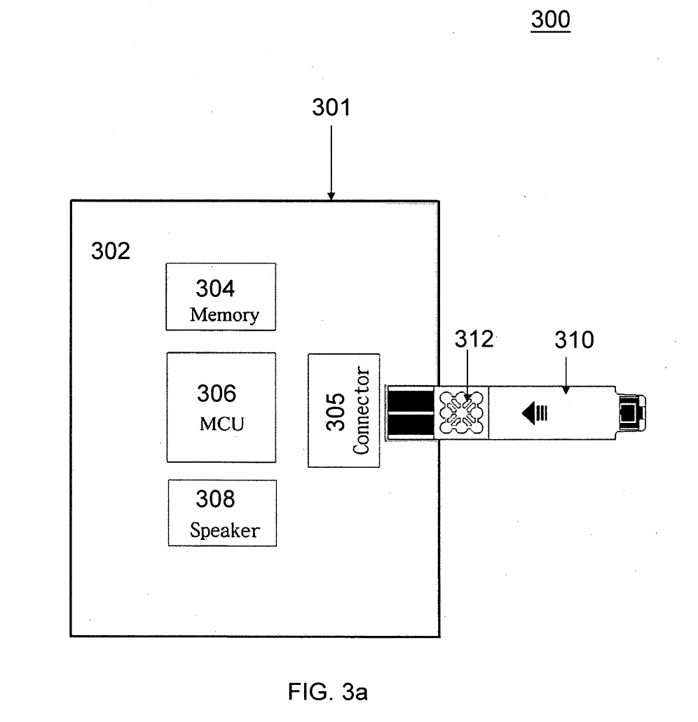

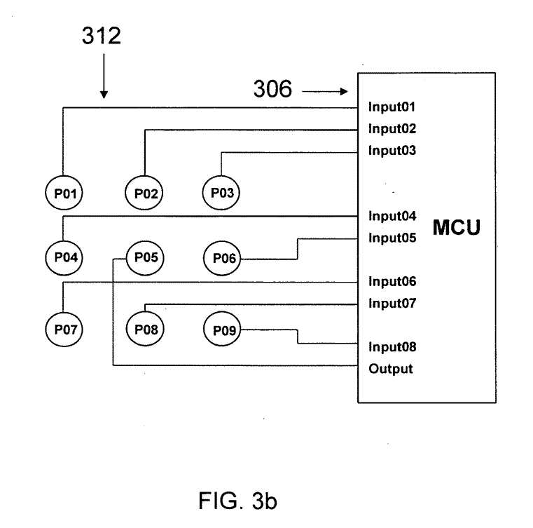

In one embodiment of the present invention, the plurality of digital on and off points, such as digital on and off points 112, 114, 116, 118, 120, 122, 124 and 126, may be implemented through a general purpose input/output (GPIO) connection. In accordance with the present invention, each of the digital on and off points may be enabled by providing an electrical connection therethrough. The enablement of each of the digital on and off points will be described in detail later in reference to FIG. 3b.

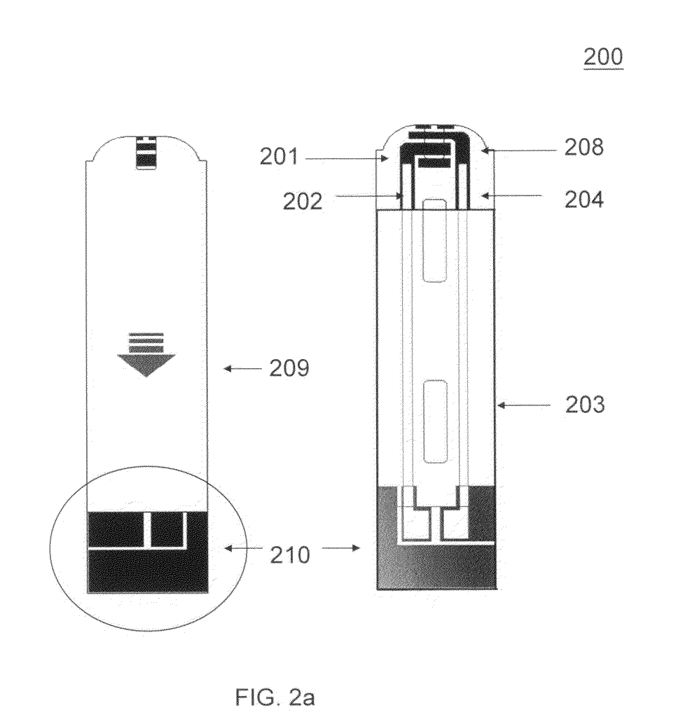

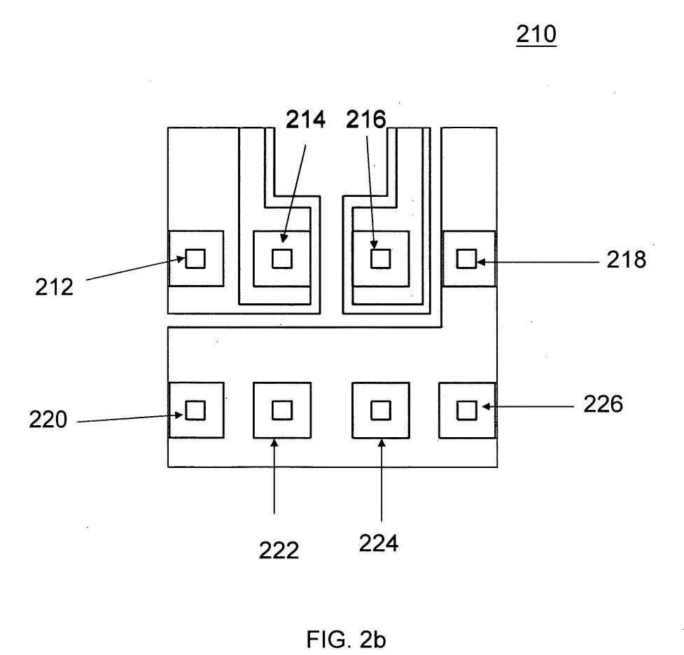

Refer now to FIGS. 2a and 2b, which are schematic diagrams of another exemplary biosensor in accordance with one embodiment of the present invention. In one embodiment of the present invention, the biosensor 200 may include a substrate (not shown) and a non-metal layer 201 disposed thereon. As mentioned above, the substrate (not shown) may be made of an insulating material, such as polyethylene terephthalate (PET) or the like. The non-metal layer 201 of the present invention may be covering the entire substrate (not shown) or partially covering the substrate (not shown) so that a portion of the substrate (not shown) may be exposed.

In accordance with the present invention, the non-metal layer 201 may be provided with a plurality of electrodes. As shown in FIG. 2a, the non-metal layer 201 may be provided with a working electrode 202 and a reference electrode 204. The working electrode 202 and the reference electrode 204 may be screen printed with conductive paste to form a reaction region 208 at one end of the non-metal layer 201, such as the first end of the non-metal layer 201. In accordance with the present invention, the reaction region 208 may be applied with an enzyme so that when a test sample performs a chemical reaction with the enzyme at the reaction region 208, an electrical response may be generated.

In one embodiment of the present invention, in addition to the working electrode 202 and the reference electrode 204, the non-metal layer 201 may be provided with a counter electrode (not shown), also called an auxiliary electrode. The counter electrode (not shown) may be used to make a connection to the electrolyte so that a current can be applied to the working electrode 202. In one embodiment of the present invention, the counter electrode (not shown) may be made of an inert material, such as a noble metal, to keep it from dissolving.

In accordance with the present invention, a conductive film 203 may be disposed on the non-metal layer 201. The conductive film 203 may be made of Indium Tin Oxide (ITO), Indium Zinc Oxide (IZO) or the like. The integrated information unit 210 may be provided on the conductive film 203 at another end of the non-metal layer 201, such as the second end of the non-metal layer 201. In one embodiment of the present invention, the integrated information unit 210 may be formed by cutting on the second end of the conductive film 203 so as to create different resistances. In one example, the cutting process may be a laser cutting process. In another embodiment of the present invention, the integrated information unit 210 may be formed by a thermal, IR, or UV curing process. In the example of laser cutting process, the integrated information unit 210 may be formed by laser cutting a number of strips in different lengths or widths on the conductive film 203. The different lengths or widths of strips would result in different resistances on the conductive film 203, thereby creating different electrical signals corresponding to the test sample information.

In accordance with the present invention, the biosensor 200 may further include an upper lid 209 to cover a portion of the non-metal layer 201. In one embodiment of the present invention, the upper lid 209 may cover a portion of the conductive film 203 while exposing the reaction region 208 and the integrated information unit 210, as shown in FIG. 2a.

The integrated information unit 210 of the present invention may contain both test sample information and coding information. In one embodiment, the test sample information may include the electrical response generated when a test sample performs a chemical reaction with the enzyme at the reaction region 208, whereas the coding information may include code patterns, which uniquely identify a particular biosensor, calibration information, or any other safety information to prevent any improper operation.

In one embodiment of the present invention, the integrated information unit 210 may include a plurality of digital on and off points, such as points 212, 214, 216, 218, 220, 222, 224 and 226 in FIG. 2b. Although FIG. 2b shows 8 digital on and off points, those skilled in the art should know that the integrated information unit 210 may include more or less than 8 digital on and off points to indicate the test sample information and the coding information.

In one embodiment of the present invention, the plurality of digital on and off points 212, 214, 216, 218, 220, 222, 224 and 226 may be divided into the first group and the second group. For example, the digital on and off points 212, 214 and 216 may belong to the first group while the digital on and off points 218, 220, 222, 224 and 226 may belong to the second group. However, those skilled in the art should know that the present invention is not limited to these arrangements. Any other ways of grouping the plurality of digital on and off points 212, 214, 216, 218, 220, 222, 224 and 226 are included in the present invention.

In accordance with the present invention, the first group of the plurality of digital on and off points, for example, digital on and off points 212, and 214 may be electrically coupled to the working electrode 202 and the reference electrode 204, respectively, so as to generate signals corresponding to the test sample information. Optionally, the digital on and off points 216 may be electrically coupled to the counter electrode (not shown) so as to generate signals corresponding to the test sample information. As discussed above, the test sample information may include the electrical response generated when a test sample performs a chemical reaction with the enzyme at the reaction region 208. On the other hand, the second group of the plurality of digital on and off points, for example, digital on and off points 218, 220, 222, 224 and 226 may be capable of generating signals corresponding to the coding information. As discussed above, the coding information may include code patterns, which uniquely identify a particular biosensor, calibration information, or any other safety information to prevent any improper operation.

In one embodiment of the present invention, the plurality of digital on and off points, such as digital on and off points 212, 214, 216, 218, 220, 222, 224 and 226, may be implemented through a general purpose input/output (GPIO) connection. In accordance with the present invention, each of the digital on and off points may be enabled by providing an electrical connection therethrough. The enablement of each of the digital on and off points will be described in detail later in reference to FIG. 3b.

Refer now to FIG. 3a, which illustrates a block diagram of an exemplary biosensor testing system in accordance with one embodiment of the present invention. As shown in FIG. 3a, the biosensor testing system 300 of the present invention may include a biosensor testing device 301 and a biosensor 310. The biosensor testing device 301 may be used in connection with the biosensor 310 to provide a test result of a test sample to a user. For example, the biosensor testing device 301 may be used in connection with the biosensor 310 to provide the concentration of glucose in a blood sample.

In one embodiment of the present invention, the biosensor testing device 301 may include a housing 302. The housing 302 of the present invention may be in the shape of a pen for ease of carry. In accordance with the present invention, the housing 302 may define a slot (not shown) for receiving the biosensor 310. The biosensor testing device 301 may further include a connector 305. The connector 305 may be electrically coupled to a microcontroller unit 306 provided within the housing 302. As explained above, the biosensor 310 may include an integrated information unit 312 so that when the biosensor 310 is received in the slot (not shown), the connector 305 may transmit the information contained in the integrated information unit 312, such as test sample information and coding information, to the microcontroller unit 306.

In one embodiment of the present invention, the connector 305 may be implemented by a single connector. The single connector of the present invention may have a plurality of terminals for electrically coupling to the biosensor 310 so as to transmit both the test sample information and the coding information contained in the integrated information unit 312 on the biosensor 310. In another embodiment of the present invention, the connector 305 may be assembled with the first connector and the second connector. Each of the first connector and the second connector may have a plurality of terminals for electrically coupling the biosensor 310. In one example, the first connector may be used for transmitting the test sample information to the microcontroller unit 306, whereas the second connector may be used for transmitting the coding information to the microcontroller unit 306. In one implementation, the second connector may be a SIM card connector for transmitting the coding information.

In one embodiment of the present invention, the microcontroller unit 306 may be electrically coupled to a memory 304 so that the test result calculated by the microcontroller unit 306 may be stored therein. Additionally, the memory 304 may store information contained in the integrated information unit 312, such as test sample information and coding information.

In one embodiment of the present invention, the biosensor testing device 301 may further include a speaker 308 electrically coupled to the microcontroller unit 306 so that when the test result is calculated by the microcontroller unit 306, the test result may be output to the speaker 308. In other words, the biosensor testing device 301 may be capable of reading the test result out loud.

Refer now to FIG. 3b, which illustrates a schematic diagram of the GPIO in connection with a microcontroller implemented in accordance with one embodiment of the present invention. In the above example where the digital on and off points are implemented by the GPIO connection, each of the plurality of digital on and off points, such as digital on and off points 112, 114, 116, 118, 120, 122, 124 and 126 shown in FIG. lb, may include, for example, 9 GPIO points 312. As shown in FIG. 3b, one of the points, such as P09, may be designated as an out put point, while the rest of the points, such as P01˜P08, may be designated as input points in the microcontroller unit 306. In one embodiment of the present invention, when P09 is enabled, any of the rest of the points, such as P01˜P08, having an electrical connection therewith will be able to transmit electrical signals to the microcontroller unit 306. In other words, the connection between any of the GPIO points 312 designated as input points and the output point may act like a switch, and when any one of the input points is connected to the enabled output points, the switch is turned on. Therefore, the 8 connections may generate 256 combinations. For example, P01 may be connected to P09 in one combination. In another combination, P04 may be connected to P09, and P09 may be connected to P05 at the same time.

Refer now to FIG. 4, which is a schematic view of an internal structure of a biosensor testing device in accordance with one embodiment of the present invention. As shown in FIG. 4, the biosensor testing device 400 may be used in connection with a biosensor 402. The biosensor testing device 400 of the present invention may be provided with a housing 401. The housing of the present invention may be provided with a connector 405. One of the functions of the connector 405 shown in FIG. 4 is similar to that of the connector 305 in that the connector 405 is capable of transmitting the information contained in the biosensor 402 to the microcontroller disposed within the housing 401.

In accordance with the present invention, the biosensor testing device 400 may include a positioning unit. The positioning unit of the present invention may include the first positioning element 403 and the second positioning element 404. The first positioning element 403 and the second positioning element 404 may be used to properly position the biosensor 402 inside the housing 401 of the biosensor testing device 400. In one embodiment of the present invention, the first and second positioning elements 403 and 404 may be implemented by a set of hooks. However, those skilled in the art may utilize other positioning elements capable of achieving the same effect as the elements described herein.

The biosensor testing device 400 of the present invention may further include an ejection unit. The ejection unit of the present invention may help eject the biosensor 402. In one embodiment of the present invention, the ejection unit may include a plurality of flexible elements, such as flexible elements 410 and 412. The flexible elements 410 and 412 may be connected to the first positioning unit 403 and the second positioning unit 404. In one embodiment of the present invention, the flexible elements 410 and 412 may be implemented by springs. However, those skilled in the art may utilize other flexible elements capable of achieving the same effect as the elements described herein.

In one embodiment of the present invention, when a user inserts the biosensor 402 into the biosensor testing device 400, the biosensor 402 is pushed inward causing the flexible elements 410 and 412 to change their shape. At the same time, the second positioning unit 404 is pushed towards the first poisoning unit 403. When the flexible elements 410 and 412 are configured so that when completely depressed, the user pushing the biosensor 402 will feel that the biosensor 402 cannot be pushed any further. As a result, the user will release the biosensor 402 causing the second positioning element 404 connected to the flexible elements 410 and 412 to be pushed outward by the flexible force exerted by the flexible elements 410 and 412. The second positioning element 404 will eventually be stopped by the first positioning element 403, thereby properly positioning the biosensor 402 in the biosensor testing device 400.

In one embodiment of the present invention, the ejection unit may further include a push button (not shown) provided on the housing 302. When the user presses the push button, the push button would allow the first positioning element 403 and the second positioning element 404 to disconnect from each other; as a result, the biosensor 402 is ejected out of the slot (not shown) through the flexible force exerted by the flexible elements 410 and 412.

In another embodiment of the present invention, the ejection unit may include a slidable button (not shown) provided outside of the housing. In one example, the slidable button may be connected to the first internal lever (not shown) provided within the housing 402. The first internal lever may be connected to the connector 405 disposed within the housing so that when the user slides the slidable button, the connector 405 would move in relation to the slidable button along the slot, thereby pushing the biosensor 402 out of the biosensor testing device 400. In another example, the first internal lever may be connected to the second lever (not shown) disposed within the housing. The second lever may in turn be connected to the connector 405 so that when the user slides the slidable button, the connector 405 would be moved by the first lever and the second lever interconnected, thereby pushing the biosensor 402 out of the biosensor testing device 400.

While the invention has been described in conjunction with exemplary preferred embodiments, it is to be understood that many alternatives, modifications, and variations will be apparent to those skilled in the art in light of the foregoing description. Accordingly, the present invention embraces all such alternatives, modifications, and variations. All matters set forth herein or shown in the accompanying drawings are to be interpreted in an illustrative and non-limiting sense.

What is claimed is:

1. An electrochemical biosensor, comprising:
a substrate;
a metal layer disposed on said substrate, wherein a first end of said metal layer is formed with a reaction region by a working electrode and a reference electrode provided on said metal layer, said reaction region is applied with an enzyme so that an electrical response is generated when said enzyme and a test sample form a chemical reaction, and a second end of said metal layer is provided with an integrated information unit to provide both coding information about said biosensor and said electrical response,
wherein said integrated information unit is provided with a plurality of digital on and off points capable of generating signals corresponding to said coding information and said electrical response.

2. The biosensor of claim 1, wherein said integrated information unit is formed by cutting on said second end of said metal layer so as to create different resistances.

3. The biosensor of claim 2, wherein said cutting process can be a laser cutting process.

4. The biosensor of claim 1, wherein each of said plurality of digital on and off points can be enabled by providing an electrical connection therethrough.

5. The biosensor of claim 4, wherein said plurality of digital on and off points can be implemented through a general purpose input/output (GPIO) connection.

6. The biosensor of claim 1, wherein said coding information is calibration information.

7. The biosensor of claim 1, wherein said integrated information unit is provided on a conductive film covering at least said second end of said metal layer.

8. The biosensor of claim 7, wherein said conductive film may be an Indium Tin Oxide (ITO) conductive film, an Indium Zin Oxide (IZO) conductive film, or any equivalent thereof.

9. The biosensor of claim 1, wherein said integrated information unit is provided on a same side of said metal layer as said working electrode and said reference electrode or on an opposite side of said metal layer.

10. The biosensor of claim 1, wherein said metal layer further has a counter electrode to facilitate a current flow to said working electrode.

11. The biosensor of claim 1, wherein said working electrode and said reference electrode can be made of a first metal material and said integrated information unit can be made of a second metal material, said first metal material may be the same as said second metal material or different from said second metal material.

12. The biosensor of claim 1, wherein said plurality of digital on and off points can be divided into a first group and a second group, and wherein any of said plurality of digital on and off points in said first group is assigned to generate signals corresponding to said electrical response, whereas any of said plurality of digital on and off points in said second group is assigned to generate signals corresponding to said coding information.

13. The biosensor of claim 12, wherein said plurality of digital on and off points in said first group is electrically coupled to said working electrode and said reference electrode.

14. The biosensor of claim 12, wherein said plurality of digital on and off points in said first group is electrically coupled to a counter electrode.

15. An electrochemical biosensor, comprising:
a substrate;
a non-metal layer disposed on said substrate, wherein a first end of said non-metal layer is formed with a reaction region by a working electrode and a reference electrode provided on said non-metal layer, said reaction region is applied with an enzyme so that an electrical response is generated when said enzyme and a test sample form a chemical reaction,
a conductive film layer having an integrated information unit provided thereon so as to provide both coding information about said biosensor and said electrical response,
wherein said integrated information unit is provided with a plurality of digital on and off points capable of generating signals corresponding to said coding information and said electrical response.

16. The biosensor of claim 15, wherein said integrated information unit is formed by cutting on said conductive film layer so as to create different resistances.

17. The biosensor of claim 16, wherein said cutting process can be a laser cutting process.

18. The biosensor of claim 15, wherein each of said plurality of digital on and off points can be enabled by providing an electrical connection therethrough.

19. The biosensor of claim 18, wherein said plurality of digital on and off points can be implemented through a general purpose input/output (GPIO) connection.

20. The biosensor of claim 15, wherein said coding information is calibration information.

21. The biosensor of claim 15, wherein said conductive film layer can be disposed on a same side of said substrate as said non-metal layer or an opposite side of said substrate.

22. The biosensor of claim 15, wherein said conductive film may be an Indium Tin Oxide (ITO) conductive film, an Indium Zin Oxide (IZO) conductive film, or any equivalent thereof.

23. The biosensor of claim 15, wherein said non-metal layer further has a counter electrode to facilitate a current flow to said working electrode.

24. The biosensor of claim 15, wherein said plurality of digital on and off points can be divided into a first group and a second group, and wherein any of said plurality of digital on and off points in said first group is assigned to generate signals corresponding to said electrical response, whereas any of said plurality of digital on and off points in said second group is assigned to generate signals corresponding to said coding information.

25. The biosensor of claim 24, wherein said plurality of digital on and off points in said first group is electrically coupled to said working electrode and said reference electrode.

26. The biosensor of claim 24, wherein said plurality of digital on and off points in said first group is electrically coupled to a counter electrode.

27. An electrochemical biosensor testing device for use with a biosensor provided with an integrated information unit containing both coding information about said biosensor, and an electrical response generated when an enzyme applied on a reaction region formed by a working electrode and a reference electrode provided on said biosensor forms a chemical reaction with a test sample, said testing device comprising:
a housing defining an slot for receiving said biosensor;
a single connector having a plurality of terminals for electrically coupling to said biosensor; and
a microcontroller electrically coupled to said single connector so as to calculate a test result,
wherein said single connector is capable of transmitting both said coding information and said electrical response to said microcontroller.

28. The device of claim 27, further comprising an ejection unit to facilitate an ejection of said biosensor.

29. The device of claim 28, wherein said ejection unit has a slidable button provided outside of said housing, said slidable button is connected to a first internal lever and a second internal lever interconnected to said single connector within said housing so that when a user slides said slidable button, said single connector moves along said slot to push said biosensor received in said slot out.

30. The device claim 28, further comprising a positioning unit, wherein said positioning unit has a plurality of flexible elements, and wherein said plurality of flexible elements are depressed as a user pushes said biosensor into said slot, and when said plurality of flexible elements are completely depressed, said user can push said biosensor no further.

31. The device of claim 30, wherein said positioning unit further comprises a first positioning element and a second positioning element so that when said user releases said biosensor, said first positioning element is connected to said second positioning element by a force exerted by said plurality of flexible elements so as to properly position said biosensor in said slot.

32. The device of clam 28, wherein said ejection unit has a push button provided outside of said housing, and when a user pushes said push button, said push button allows said first positioning element and said second positioning element to disconnect from each other so that said biosensor is ejected out of said slot through a force exerted by said plurality of flexible elements.

33. The device of claim 27, further comprising a speaker module electrically coupled to said microcontroller so as to output said test result.

34. The device of claim 27, further comprising a memory electrically coupled to said microcontroller such that said test result can be stored therein.

35. The device of claim 27, wherein said housing is in a pen-like shape.

36. An electrochemical biosensor testing device for use with a biosensor provided with an integrated information unit containing both coding information about said biosensor, and an electrical response generated when an enzyme applied on a reaction region formed by a working electrode and a reference electrode provided on said biosensor forms a chemical reaction with a test sample, said testing device comprising:
a housing defining an slot for receiving said biosensor;
a first connector and a second connector, each having a plurality of terminals for electrically coupling to said biosensor; and
a microcontroller electrically coupled to said first and said second connectors so as to calculate a test result,
wherein said first connector is capable of transmitting said coding information to said microcontroller, whereas said second connector is capable of transmitting said electrical response to said microcontroller.

37. The device of claim 36, further comprising an ejection unit to facilitate an ejection of said biosensor.

38. The device of claim 37, wherein said ejection unit has a slidable button provided outside of said housing, said slidable button is connected to a first internal lever and a second internal lever interconnected to said single connector within said housing so that when a user slides said slidable button, said single connector moves along said slot to push said biosensor received in said slot out.

39. The device claim 37, further comprising a positioning unit, wherein said positioning unit has a plurality of flexible elements, and wherein said plurality of flexible elements are depressed as a user pushes said biosensor into said slot, and when said plurality of flexible elements are completely depressed, said user can push said biosensor no further.

40. The device of claim 39, wherein said positioning unit further comprises a first positioning element and a second positioning element so that when said user releases said biosensor, said first positioning element is connected to said second positioning element by a force exerted by said plurality of flexible elements so as to properly position said biosensor in said slot.

41. The device of clam 37, wherein said ejection unit has a push button provided outside of said housing, and when a user pushes said push button, said push button allows said first positioning element and said second positioning element to disconnect from each other so that said biosensor is ejected out of said slot through a force exerted by said plurality of flexible elements.

42. The device of claim 36, further comprising a speaker module electrically coupled to said microcontroller so as to output said test result.

43. The device of claim 36, further comprising a memory electrically coupled to said microcontroller such that said test result can be stored therein.

44. The device of claim 37, wherein said housing is in a pen-like shape.

45. An electrochemical biosensor testing system, comprising:
a biosensor provided with an integrated information unit containing both coding information about said biosensor, and an electrical response generated when an enzyme applied on a reaction region formed by a working electrode and a reference electrode provided on said biosensor forms a chemical reaction with a test sample; and
a biosensor testing device with a housing defining an slot for receiving said biosensor, said testing device having a single connector with a plurality of terminals for electrically coupling to said biosensor, and a microcontroller electrically coupled to said single connector so as to calculate a test result based on said coding information and said electrical response,
wherein said integrated information unit is provided with a plurality of digital on and off points to generate signals corresponding to said electrical response and said coding information.

46. The system of claim 45, wherein said plurality of digital on and off points is divided into a first group and a second group, and wherein said first group of said digital on and off points is electrically coupled to said working electrode and said reference electrode so as to generate signals corresponding to said electrical response, whereas said second group of said digital on and off points generates signals corresponding to said coding information.

47. The system of claim 45, wherein said biosensor has a substrate and a metal layer, and wherein a first end of said metal layer is provided with said reaction region, and a second end of said metal layer is provided with said integrated information unit by cutting on said second end of said metal layer so as to create different resistances.

48. The system of claim 47, wherein said cutting process can be a laser cutting process.

49. The system of claim 45, wherein any of said plurality of digital on and off points can be enabled by providing an electrical connection therethrough.

50. The system of claim 45, wherein said plurality of digital on and off points can be implemented through a general purpose input/output (GPIO) connection.

51. The system of claim 45, wherein said coding information is calibration information.

52. The system of claim 45, wherein said biosensor has a substrate and a non-metal layer, and wherein a first end of said non-metal layer is provided with said reaction region, and said integrated information unit is provided on a conductive film disposed on said non-metal layer covering at least a second end of said non-metal layer.

53. The system of claim 52, wherein said conductive film may be an Indium Tin Oxide (ITO) conductive film, an Indium Zin Oxide (IZO) conductive film, or any equivalent thereof.

54. The system of claim 47, wherein said integrated information unit is provided on a same side of said metal layer as said working electrode and said reference electrode or on an opposite side of said metal layer.

55. The system of claim 47, wherein said metal layer further has a counter electrode to facilitate a current flow to said working electrode.

56. The system of claim 45, wherein said working electrode and said reference electrode can be made of a first metal material and said integrated information unit can be made of a second metal material, said first metal material is the same as said second metal material, or said first metal material is different from said second metal material.

57. The system of claim 52, wherein said integrated information unit is provided on a same side of said substrate layer as said working electrode and said reference electrode or on an opposite side of said substrate.

58. The system of claim 46, wherein said first group of said plurality of digital on and off points is electrically coupled to a counter electrode.

59. The system of claim 45, wherein said biosensor testing device further comprises an ejection unit to facilitate an ejection of said biosensor.

60. The system of claim 59, wherein said ejection unit has a slidable button provided outside of said housing, said slidable button is connected to a first internal lever and a second internal lever interconnected to said single connector within said housing so that when a user slides said slidable button, said single connector moves along said slot to push said biosensor received in said slot out.

61. The system of claim 59, wherein said biosensor further comprises a positioning unit, wherein said positioning unit has a plurality of flexible elements, and wherein said plurality of flexible elements are depressed as a user pushes said biosensor into said slot, and when said plurality of flexible elements are completely depressed, said user can push said bio sensor no further.

62. The system of claim 61, wherein said positioning unit further comprises a first positioning element and a second positioning element so that when said user releases said biosensor, said first positioning element is connected to said second positioning element by a force exerted by said plurality of flexible elements so as to properly position said biosensor in said slot.

63. The system of claim 59, wherein said ejection unit has a push button provided outside of said housing, and when a user pushes said push button, said push button allows said first positioning element and said second positioning element to disconnect from each other so that said biosensor is ejected out of said slot through a force exerted by said plurality of flexible elements.

64. The system of claim 45, wherein said biosensor testing device further comprises a speaker module electrically coupled to said microcontroller so as to output said test result.

65. The system of claim 45, wherein said biosensor testing device further comprises a memory electrically coupled to said microcontroller such that said test result can be stored therein.

66. The system of claim 45, wherein said housing is in a pen-like shape.

67. The device of claim 36, wherein said second connector is a SIM card connector.
